(19) United States
(12) Patent Application Publication
(10) Pub. No.: US 2009/0174205 A1
(43) Pub. Date: Jul. 9, 2009

(54) FUNERAL CAR

(76) Inventor: Yong Sun Kim, Seoul (KR)

Correspondence Address: IPLA P.A., 3580 WILSHIRE BLVD., 17TH FLOOR, LOS ANGELES, CA, 90010, US

(21) Appl. No.: 12/095,715

(22) PCT Filed: Nov. 21, 2006
(86) PCT No.: PCT/KR2006/004889

§ 371 Date: May 30, 2008

(30) Foreign Application Priority Data
Dec. 1, 2005 (KR) 10-2005-0116188
Nov. 21, 2006 (KR) PCT/KR2006/004889

(51) Int. Cl. A61G 21/00

(52) U.S. Cl. 296/16

(57) ABSTRACT

Provided is a funeral car including: a coffin carriage box; an air-cooling duct; a coffin seating table; a cylinder enabling the coffin seating table to move along the rails to thus go in and out of the coffin carriage box; a location confirmation sensor enabling the coffin seating table to automatically go in and out of the coffin carriage box; and a sliding table which slidably moves from the coffin carriage box. Accordingly, a corpse in the coffin is quickly cooled to prevent the corpse from being decomposed and to avoid an offensive odor due to the decomposition to thereby reduce discomfort of mourners or a bereaved family. Moreover, the coffin can be automatically loaded into and unloaded from the coffin carriage box to thereby prevent the coffin from being damaged. In addition, since the coffin can be longitudinally loaded into the coffin carriage box, the coffin can be easily carried even at a narrow or small space.

### TECHNICAL FIELD

The present invention relates to a hearse or funeral car, and more particularly, to a funeral car including a coffin carriage box enabling a coffin to be automatically loaded into and unloaded from the coffin carriage box provided in the funeral car to thereby prevent the coffin from being damaged, and including a cooling duct to make a corpse in the coffin quickly cooled to thereby prevent the corpse from being decomposed and to avoid an offensive odor due to the decomposition to thereby reduce discomfort of mourners or a bereaved family, in which since the coffin can be longitudinally loaded into the coffin carriage box, the coffin can be easily carried even at a narrow or small space.

### BACKGROUND ART

A conventional hearse or funeral car includes a coffin carriage box attached to the floor of the rear portion of the funeral car in which the door of the coffin carriage box can be opened and closed, and fixed rails which are longitudinally provided in the left and right sides of the coffin carriage box left on the inner-bottom surface of the coffin carriage box. Moving rails are slidably installed on the fixed rails. A coffin seating table is attached on the moving rails so that the coffin seating table is slidably moved together with the moving rails. A stopper is attached upwards to the leading end of the coffin seating table, and a locker attached to the lower surface of the coffin carriage box is provided at the back end of the coffin seating table, so as to lock the coffin seating table.

The coffin carriage box is fixed and installed in the funeral car in the longitudinal direction at the central portion of the funeral car. Thus, when a coffin is loaded into the funeral car, the rear door of the coffin carriage box is opened and both the moving rails and the coffin situating table which are installed in the inner floor of the coffin carriage box are pulled by the hand and are withdrawn out of the funeral car. Then, the coffin in which a corpse is situated is put on the coffin situating table. Then, the coffin is slid up to a stopper formed at the leading end of the coffin situating table so as to closely contact the coffin situating table, and to then make the coffin tightly bound to the coffin situating table using straps.

Then, the coffin situating table on which the coffin has been situated and the moving rails are pushed into the coffin carriage box, until the coffin situating table and the moving rails reach the leading ends of the rails. Then, the coffin situating table is fixed so as not to move using a locker attached to the inner floor of the coffin carriage box, to accordingly enable the funeral car to carry the coffin to a burial ground. In the case that the coffin is unloaded from the coffin carriage box to the burial ground, the unloading work of the coffin is performed in an order reverse to the above-described order.

However, since the rails are longitudinally installed in the coffin carriage box of the conventional funeral car, and if the rails are pulled up to the rear portion of the funeral car to then be withdrawn from the coffin carriage box, and then the coffin is turned about, the load of the coffin is concentrated on the inner portion of the rails and thus the rails may not smoothly work.

Moreover, the coffin is situated on the rails fixed to the bottom of the coffin situating table and then the coffin situating table should be pushed up to the front leading ends of the rails. In the case that the coffin situating table is severely pushed up to the front leading ends of the rails, the former bumps into the latter and then an impact may affect the inner portion of the coffin to thereby cause the corpse in the coffin to change the position.

### DISCLOSURE OF THE INVENTION

To solve the above problems, it is an object of the present invention to provide a funeral car including a coffin carriage box enabling a coffin to be automatically loaded into and unloaded from the coffin carriage box provided in the funeral car to thereby prevent the coffin from being damaged, and including a cooling duct to make a corpse in the coffin quickly cooled for example within two or three minutes, to thereby prevent the corpse from being decomposed and to avoid an offensive odor due to the decomposition to thereby reduce discomfort of mourners or a bereaved family, in which since the coffin can be longitudinally loaded into the coffin carriage box, the coffin can be easily carried even at a narrow or small space.

To accomplish the above object of the present invention, according to an aspect of the present invention, there is provided a funeral car comprising: a coffin carriage box (10) which receives a coffin in the inside of the funeral car (100); a duct (20) for transferring cooling air generated from a cooling air generator (130) included in the funeral car (100) into the coffin carriage box (10), in order to maintain the cooled state of the coffin carriage box (10); a coffin seating table (11) which goes in and out of the coffin carriage box (10), along rails (14) formed in the inner floor of the coffin carriage box (10); a cylinder which enables the coffin seating table (11) to move along the rails (14) to thus go and in and out of the coffin carriage box (10); a location confirmation sensor (12) which is positioned in the coffin seating table (11) to thereby enable the coffin seating table (11) to automatically go in and out of the coffin carriage box (10); and a sliding table (50) which is formed in the front-lower portion of the coffin carriage box (10) and slidably moves from the coffin carriage box (10).

Preferably, a decoration flower (140) is decorated in the outside of the coffin carriage box (10).

Preferably, a curtain (110) is automatically drawn and undrawn at respective windows formed in the funeral car (110).

### BRIEF DESCRIPTION OF THE DRAWINGS

FIG. 1A is a perspective view illustrating a hearse or funeral car according to the present invention, in which the rear door of the funeral car is opened, the front door of a coffin carriage box is closed, and a sliding table is not spread out from the coffin carriage box;

FIG. 1B is a perspective view illustrating a hearse or funeral car according to the present invention, in which the rear door of the funeral car is opened, the front door of a coffin carriage box is opened, and a sliding table is spread out from the coffin carriage box;

FIG. 2A is a front view of the coffin carriage box viewed from the rear side of the funeral car of FIG. 1A;

FIG. 2B is a front view of the coffin carriage box viewed from the rear side of the funeral car of FIG. 1B;

FIG. 3 is a partial side sectional view illustrating the funeral car according to the present invention;

FIG. 4A is a partial side sectional view illustrating the essential portions of the funeral car of FIG. 1A according to the present invention;

FIG. 4B is a partial side sectional view illustrating the essential portions of the funeral car of FIG. 1B according to the present invention;

FIG. 5A is a partial side sectional view of the funeral car for explaining the drive of curtains according to the present invention, in which the curtains are drawn at windows;

FIG. 5B is a partial side sectional view of the funeral car for explaining the drive of curtains according to the present invention, in which the curtains are undrawn at windows; and

FIG. 6A through 6D are perspective views illustrating operation of a sliding table at the rear portion of the funeral car according to the present invention, respectively.

### BEST MODE FOR CARRYING OUT THE INVENTION

Hereinbelow, a funeral car according to a preferred embodiment of the present invention will be described with reference to the accompanying drawings.

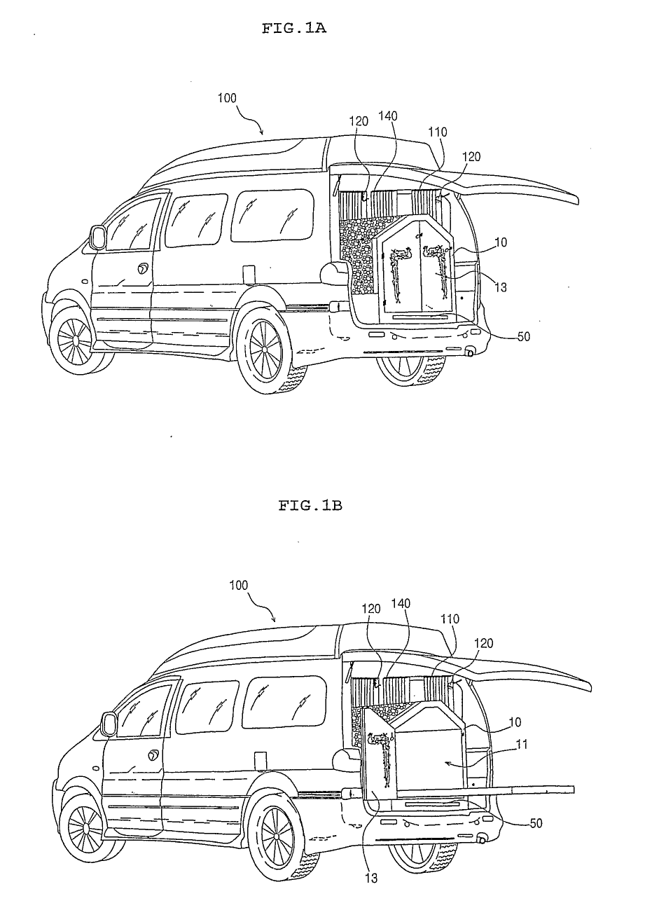

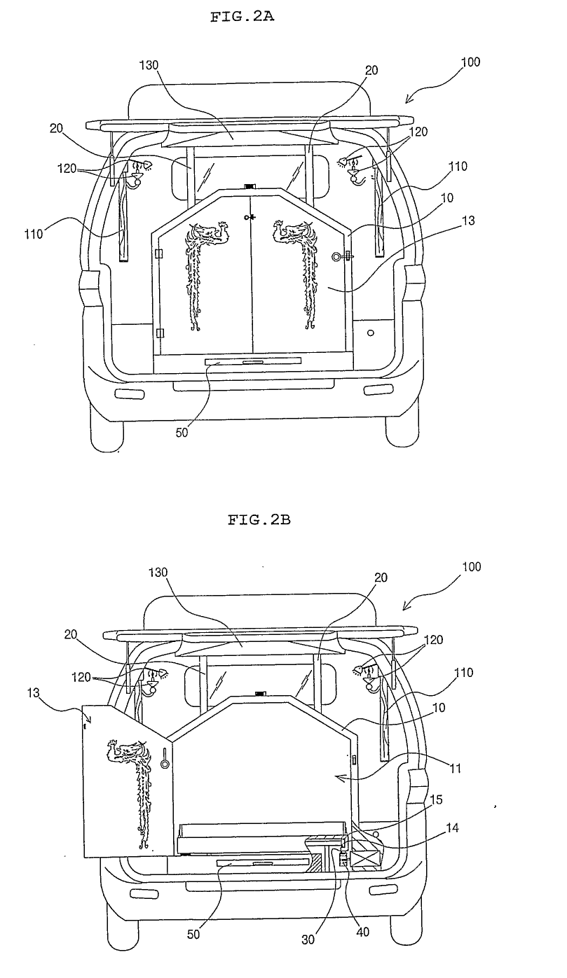

FIGS. 1A and 1B are perspective views illustrating a hearse or funeral car according to the present invention, respectively. In FIG. 1A, the rear door of the funeral car 100 is opened, the front door of a coffin carriage box 10 is closed, and a sliding table 50 is not spread out from the coffin carriage box 10. In FIG. 1B, the rear door of the funeral car 100 is opened, the front door 13 of a coffin carriage box 10 is opened, and a sliding table 50 is spread out from the coffin carriage box 10. FIG. 2A is a front view of the coffin carriage box viewed from the rear side of the funeral car of FIG. 1A, and FIG. 2B is a front view of the coffin carriage box viewed from the rear side of the funeral car of FIG. 1B.

As shown in FIGS. 1A, 1B, 2A and 2B, the funeral car 100 according to the embodiment of the present invention includes a coffin carriage box 10 which receives a coffin in the inside of the funeral car 100. A decoration flower 140 is decorated in the outside of the coffin carriage box 10. The front door 13 formed in the front portion of the coffin carriage box 10 is opened and closed in order to load and unload a coffin into and from the coffin carriage box 10, respectively. Here, the front door is a folded door.

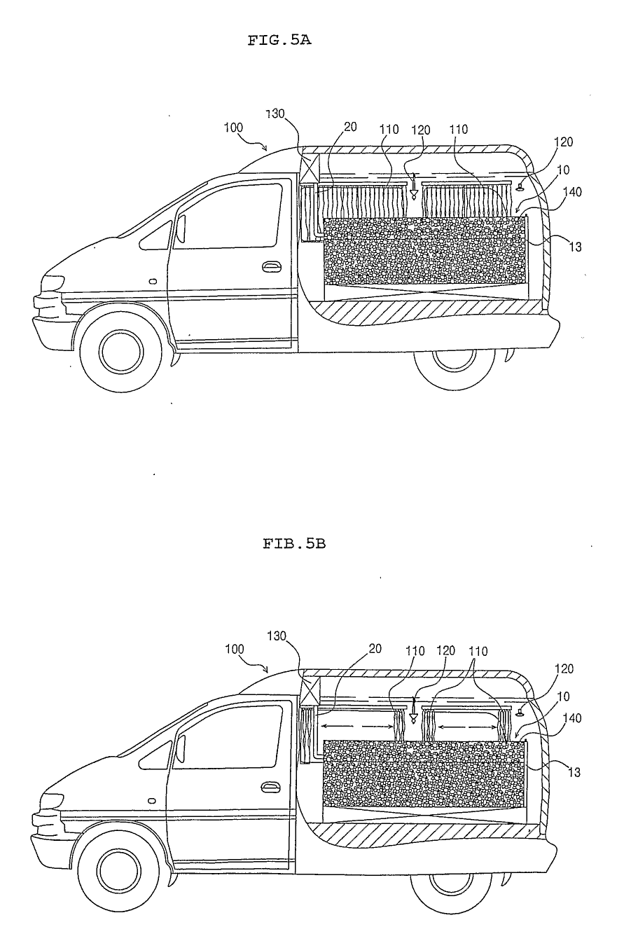

Curtains 110 are installed at windows formed in the funeral car 100. FIGS. 5A and 5B are partial side sectional views of the funeral car for explaining the drive of curtains according to the present invention, respectively. In FIG. 5A, the curtains 110 are drawn at windows, while in FIG. 5B, the curtains 110 are undrawn at windows. Here, a decoration flower 140 is decorated in the outside of the coffin carriage box 10. As shown in FIGS. 5A and 5B, the curtains 110 are automatically driven by an electric driving motor. In order to illuminate the funeral carat dark situations such as night and create the grave circumstances, lighting devices 120 are installed near the windows.

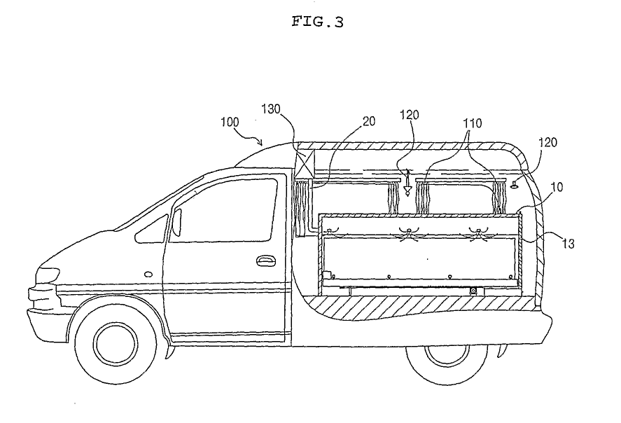

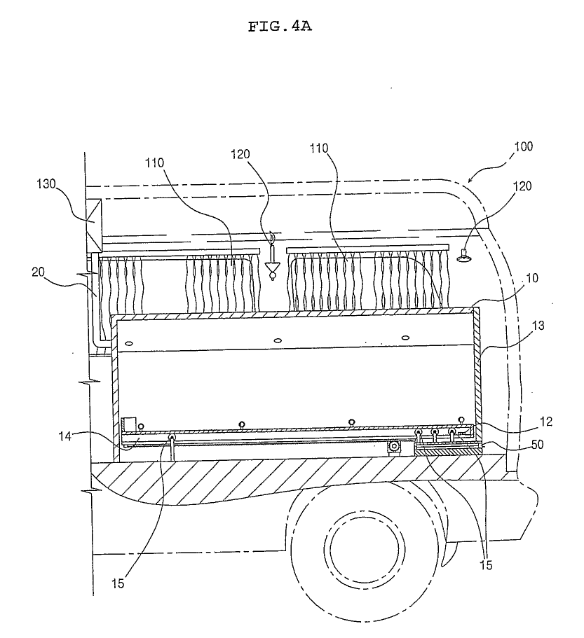

FIG. 3 is a partial side sectional view illustrating the funeral car according to the present invention.

As shown in FIG. 3, the funeral car 100 includes a duct 20 for transferring cooling air generated from a cooling air generator 130 included in the funeral car 100 into the coffin carriage box 10, in order to maintain the cooled state of the coffin carriage box 10. Accordingly, the duct 20 is connected from the cooling air generator 130 to the coffin carriage box 10. A plurality of discharge holes (not shown) are formed in the coffin carriage box 10 so that the cooling air can be discharged into the coffin carriage box 10.

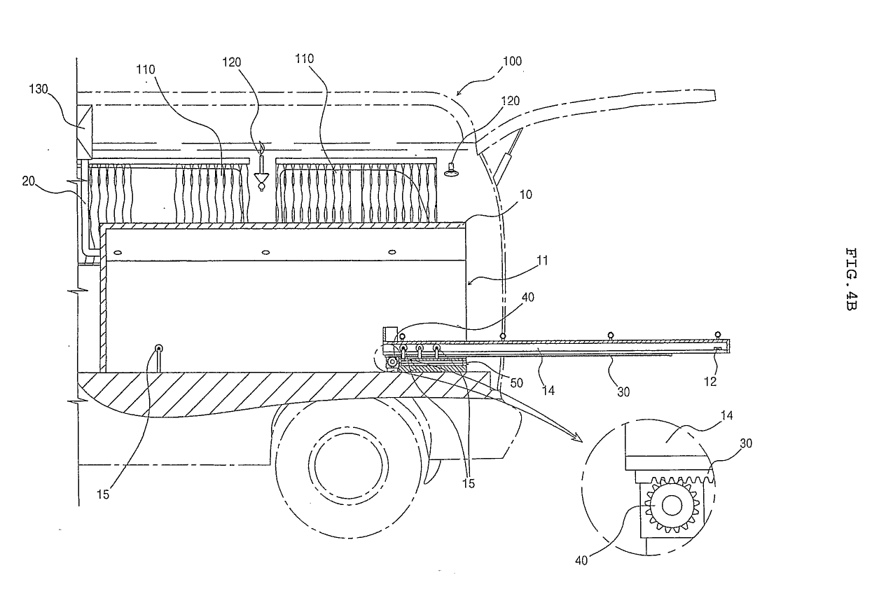

FIG. 4A is a partial side sectional view illustrating the essential portions of the funeral car of FIG. 1A according to the present invention, and FIG. 4B is a partial side sectional view illustrating the essential portions of the funeral car of FIG. 1B according to the present invention.

As shown in FIGS. 4A and 4B, a coffin seating table 11 goes in and out of the coffin carriage box 10 along rails 14 formed in the inner floor of the coffin carriage box 10. That is, C-shaped rails 14 are respectively formed in both the left and right sides of the coffin situating table 11 on the bottom of the coffin situating table 11 so that the coffin situating table 11 can be slid on the C-shaped rails 14. Rollers 15 are installed in the C-shaped rails 14 to perform a more smooth sliding between the C-shaped rails 14 and the coffin situating table 11. Here, a hydraulic cylinder (not shown) enables the coffin seating table 11 to move along the rails 14 to thus go and in and out from the coffin carriage box 10. In addition, a rack 30 and a pinion 40 are used on the bottom of the rails 14 so that the coffin situating table 11 can go in and out of the coffin carriage box 10. Furthermore, a location confirmation sensor 12 is positioned in the coffin seating table 11 to thereby enable the coffin seating table 11 to automatically go in and out of the coffin carriage box 10, at its place.

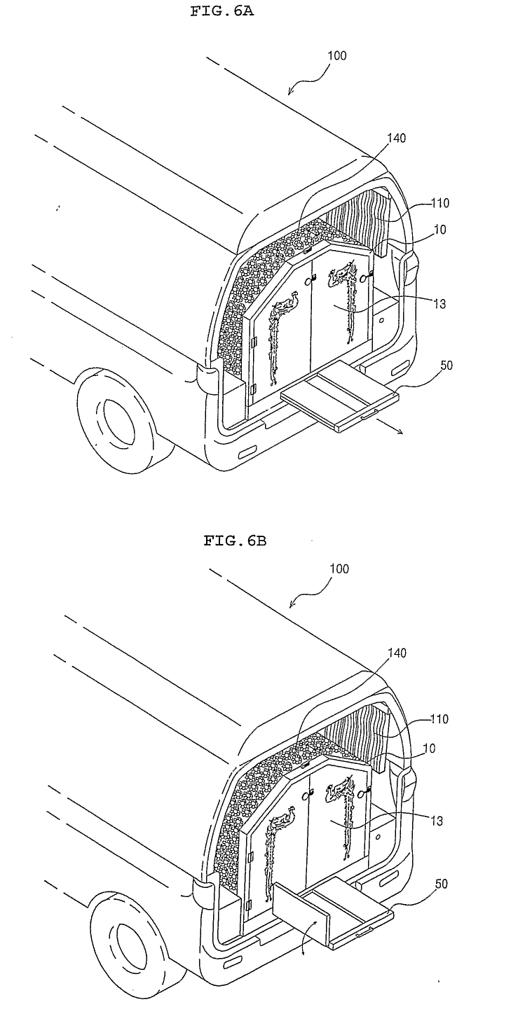

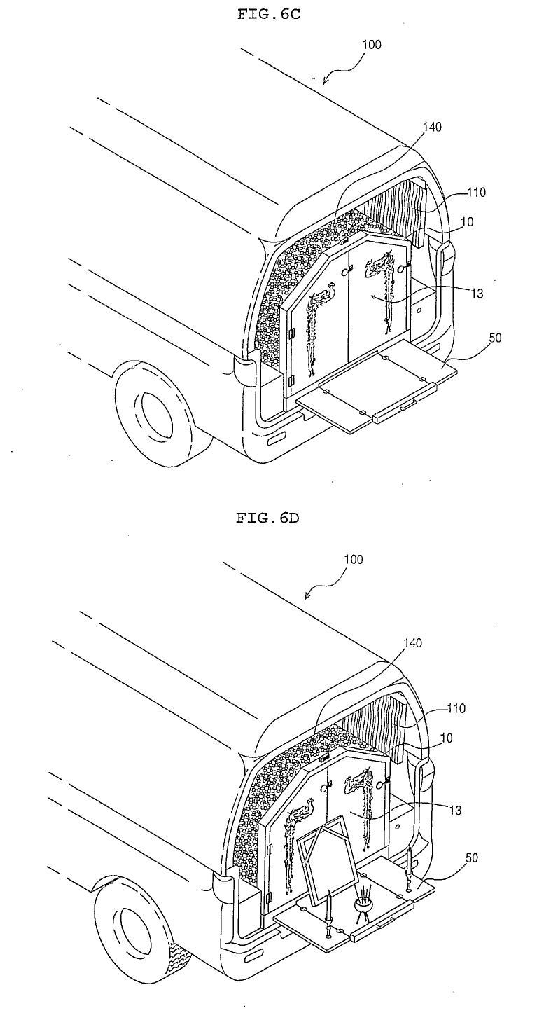

FIG. 6A through 6D are perspective views illustrating operation of a sliding table 11 at the rear portion of the funeral car 100 according to the present invention, respectively.

As shown in FIG. 6A through 6D, a sliding table 50 which is formed in the front-lower portion of the coffin carriage box 10 and slidably moves from the coffin carriage box 10. Accordingly, a portrait, candles, an incense burner etc., can be put on the sliding table 50.

As described above, the present invention provides a funeral car including a coffin carriage box enabling a coffin to be automatically loaded into and unloaded from the coffin carriage box provided in the funeral car to thereby prevent the coffin from being damaged, and including a cooling duct to make a corpse in the coffin quickly cooled for example within two or three minutes, to thereby prevent the corpse from being decomposed and to avoid an offensive odor due to the decomposition to thereby reduce discomfort of mourners or a bereaved family, in which since the coffin can be longitudinally loaded into the coffin carriage box, the coffin can be easily carried even at a narrow or small space.

As described above, the present invention has been described with respect to the particularly preferred embodiment. However, the present invention is not limited to the above embodiment, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

As described above, the present invention provides a funeral car including a coffin carriage box enabling a coffin to be automatically loaded into and unloaded from the coffin carriage box.

What is claimed is:

1. A funeral car comprising: a coffin carriage box which receives a coffin in the inside of the funeral car; a duct for transferring cooling air generated from a cooling air generator included in the funeral car into the coffin carriage box, in order to maintain the cooled state of the coffin carriage box; and a coffin seating table which goes in and out of the coffin carriage box along rails formed in the inner floor of the coffin carriage box, the funeral car further comprising:
a cylinder which enables the coffin seating table to move along the rails to thus go in and out of the coffin carriage box;
a location confirmation sensor which is positioned in the coffin seating table to thereby enable the coffin seating table to automatically go in and out of the coffin carriage box;
and a sliding table which is formed in the front-lower portion of the coffin carriage box and slidably moves from the coffin carriage box.

2. The funeral car according to claim 1, wherein a decoration flower is decorated in the outside of the coffin carriage box and a curtain is automatically drawn and undrawn at respective windows formed in the funeral car.

3. The funeral car according to claim 1, wherein a curtain is automatically drawn and undrawn at respective windows formed in the funeral car.
